(19) United States
(12) Patent Application Publication
(10) Pub. No.: US 2007/0289140 A1
(43) Pub. Date: Dec. 20, 2007

(54) Pliers for Cutting Plastic Tubes

(75) Inventor: Lionel Marcon, Donont (FR)

Correspondence Address: LEYDIG VOIT & MAYER, LTD, 700 THIRTEENTH ST. NW, SUITE 300, WASHINGTON, DC, 20005-3960, US

(73) Assignee: ETABLISSEMENTS PIERRE GREHAL ET CIE S.A., Saint-Brice-Sous-Foret (FR)

(21) Appl. No.: 10/598,704

(22) PCT Filed: Feb. 22, 2005
(86) PCT No.: PCT/FR05/00410

§ 371 Date: Apr. 5, 2007

(30) Foreign Application Priority Data
Mar. 10, 2004 (FR) 0402504

(51) Int. Cl. B23D 21/06

(52) U.S. Cl. 30/92

(57) ABSTRACT

Pliers for cutting plastic tubes includes a first lever with grooves having different widths for receiving tubes of corresponding diameters, and a second lever holding a blade. The levers are pivotally arranged with respect to each other around a pivot axis. The first lever includes a wheel with the grooves on the periphery of the wheel. The groove selected for a tube diameter is placeable in front of the blade by rotating the wheel to a corresponding position.

The invention relates to pliers for cutting plastic tubes.

In numerous cases, it is necessary to be able to cut plastic tubes very precisely and very cleanly. Furthermore, when such tubes are to be cut in the context of a new installation, it is a matter of being able to cut a large quantity of tubes in a relatively short time but nonetheless with the required precision. Under such circumstances, cutting such tubes with a saw or cutting pliers resembling pruning shears proves insufficient from the standpoint of precise and rapid cutting.

Furthermore, when plastic tubes are used in an electrical installation as cable sheaths, it is a matter of being able to cut tubes of different diameter.

The aim of the invention is to propose pliers for cutting plastic tubes, which combine the advantage of rapid and precise cutting with that of the ability to cut tubes of different diameters.

The aim of the invention is realized with pliers for cutting plastic tubes having a first lever and a second lever on a pivot axis allowing them to be pivoted with respect to one another between an open position for receiving a tube which is to be cut and a closed position at the end of cutting. The first lever is provided with grooves of different widths, each of which is intended for receiving a tube of corresponding diameter. The second lever supports a blade.

According to the invention, the pliers have a wheel mounted so as to pivot on the first lever. In the periphery of this wheel, grooves are formed in such a way that a groove chosen according to the diameter of the tube can be placed facing the blade by turning the wheel to a corresponding position.

Thanks to this arrangement of the invention, a single pair of pliers allows one to cut tubes of at least two different diameters. It is easily understood that the number of grooves that can be made in the wheel, and consequently, the number of different diameters of the tubes which can be cut with the same pliers, depends both on the diameters of the tubes and on the diameter of the wheel. In this sense, the embodiment shown in the drawings and described further below, according to which the pliers of the invention are embodied for cutting tubes of three different diameters, is only one embodiment example which should not in any case be considered limiting.

The pliers of the invention can furthermore have at least one of the following two additional characteristics:

the blade has two successive cutting edges that come to a point between them; the blade is therefore a pointed blade with an obtuse angle;

the width of each of the grooves is less than the diameter of the tube which it is intended to receive.

The one as well as the other of the two additional characteristics listed above contributes in its way towards even further facilitating work with the pliers of the invention.

In effect, the use of a pointed blade makes it possible to initiate the cutting of the tube at a point on the circumference of the tube, and from this point, to continue the cutting of the tube in two opposite directions.

And the fact that grooves are used whose width is slightly less that the diameter of the tube has the consequence that the tube is slightly deformed when it is inserted in the groove. The initially circular cross section of the tube then becomes elliptical, with the most curved part of the circumference oriented towards the blade. Thus, there is no risk of crushing the tube under the pressure of the point of the blade when it comes to rest on the tube in order to initiate cutting.

The invention furthermore also relates to the characteristics below, considered separately or in all their technically possible combinations:

the wheel consists of two disks parallel to one another and mounted so as to be axially distanced from one another on the same rotary shaft housed in the first lever, the rotary shaft being oriented parallel to the pivot axis of the levers;

each disk comprises the same number of pins as grooves, where the pins are intended to cooperate with two holes made in the lever in order to mark a stop position of the wheel for each groove;

the first lever has two branches between which the wheel is rotatably mounted, each of the two branches terminating, beyond the rotary shaft of the two disks, in a branch end provided with a hole; each disk is provided with the same number of pins as grooves, where each of the pins are intended to cooperate with the hole of the corresponding branch end in order to mark a stop position of the wheel for the selected groove;

the disks are mounted on the rotary shaft in such a way that they can be tilted slightly towards one another against a return force.

Other characteristics and advantages of the present invention will emerge from the description below of an embodiment, where the description is given with reference to the drawings in which:

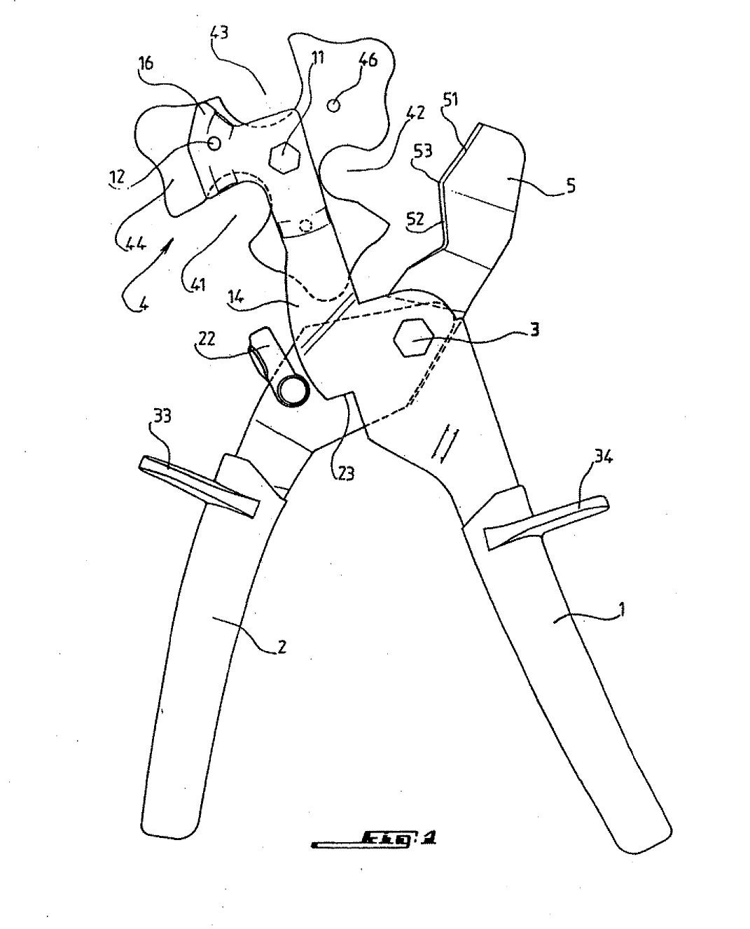

FIG. 1 shows pliers according to the invention in the open position,

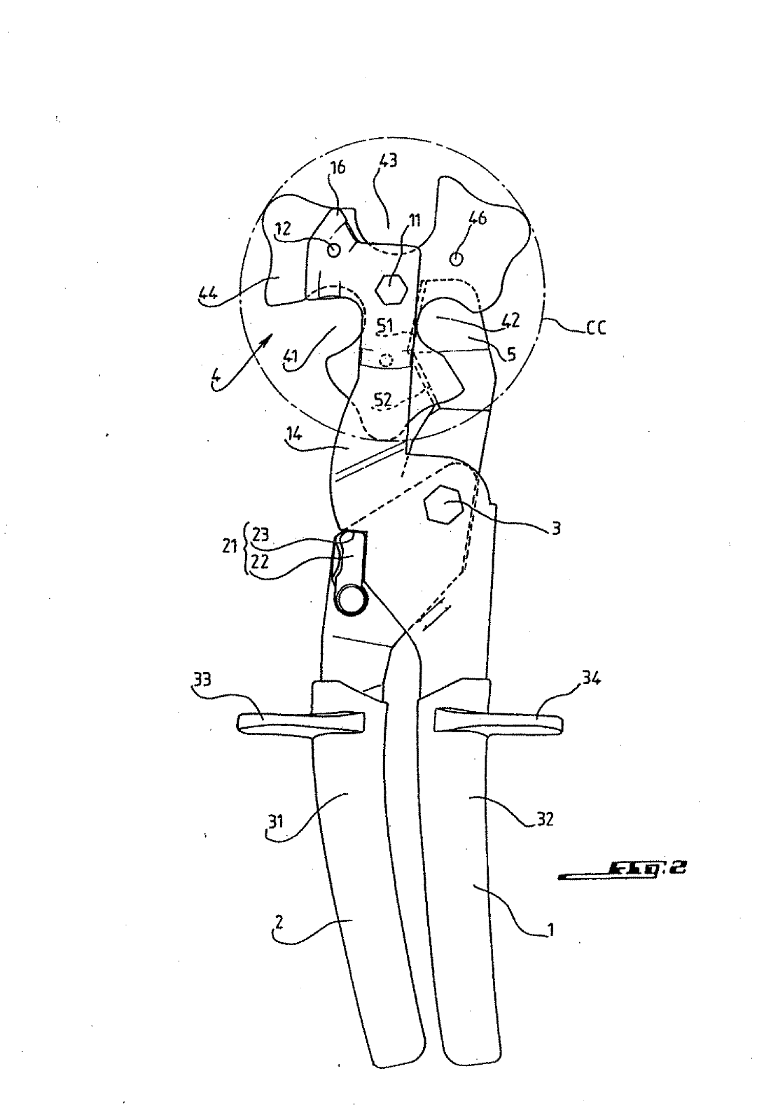

FIG. 2 shows the pliers of FIG. 1 in the closed position,

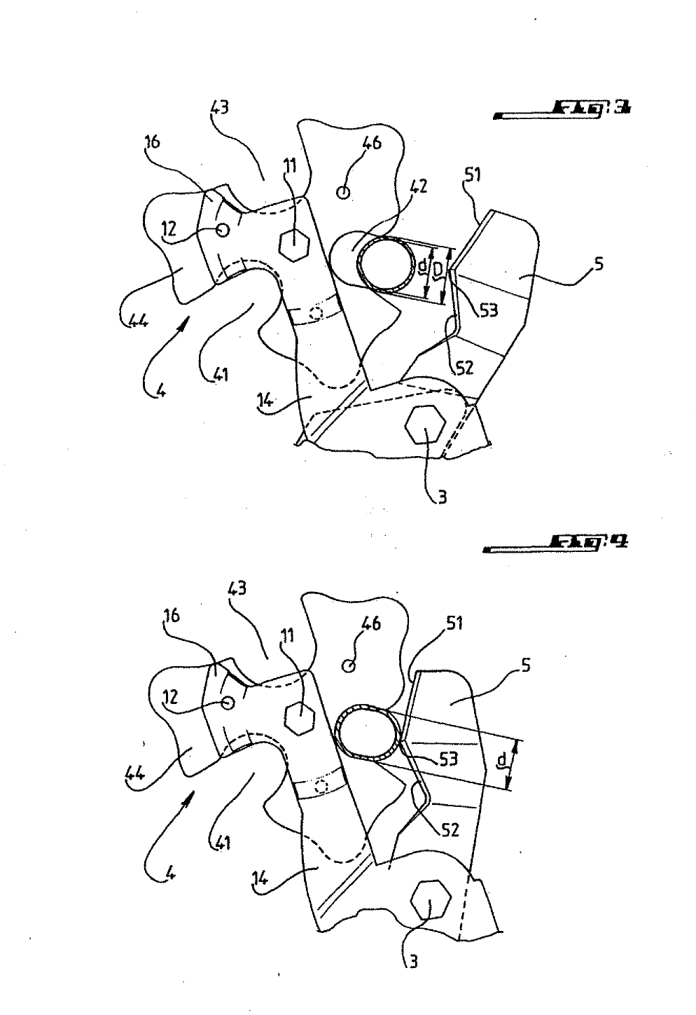

FIG. 3 shows the beginning of insertion of a tube in the pliers according to the invention,

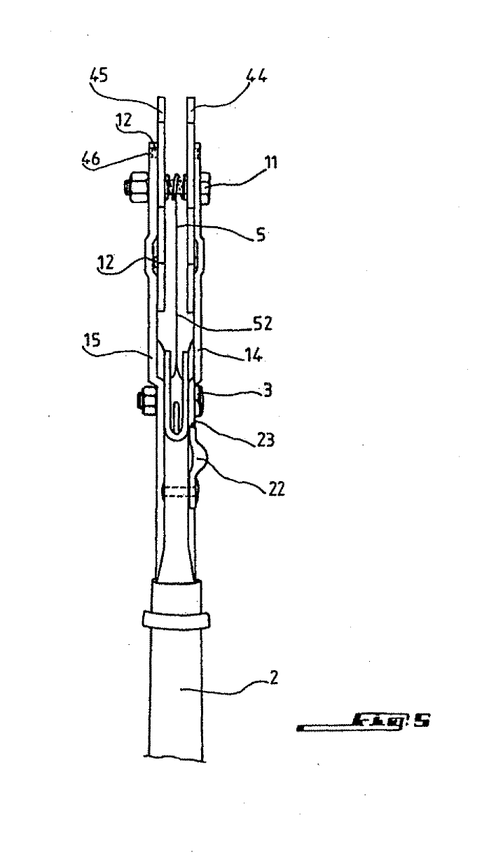

FIG. 4 shows the beginning of the cutting of a tube with the pliers according to the invention, and

FIG. 5 shows the pliers of FIG. 2 in a view perpendicular to its pivot axis.

The pliers of the invention, which are designed for cutting plastic tubes and which are represented in FIG. 1 in open position and in FIG. 2 in closed position, comprise first lever 1 and second lever 2. The two levers are articulated together on pivot axis 3 which allows them to be pivoted with respect to one another between an open position for receiving a tube which is to be cut and a closed position at the end of cutting. First and second levers 1, 2 advantageously consist of metallic sectional bars longitudinally bent roughly in the shape of a U. The sectional bars, one of which is narrower than the other, are engaged in one another and articulated on pivot axis 3.

While second lever 2 supports blade 5 with two successive cutting edges 51, 52 between which is formed point 53, first lever 1 supports wheel 4 provided with three grooves 41, 42, 43, each with a different width d and intended for receiving a tube with diameter D which is to be cut. The width d of each of these grooves is slightly less than the diameter D of the tube to which each groove is assigned. Because of this design of the invention, the cutting of a tube takes place essentially in two steps. The first step consists of the positioning of a tube on the entry of a corresponding groove, followed by depression of the tube in the groove by the blade, accompanied by local deformation of the tube. The second step consists of the cutting of the tube.

Wheel 4 consists of two disks 44, 45 parallel to one another which are mounted so as to be axially separated from one another on the same rotary shaft 11. Shaft 11 is housed in first lever 1, more precisely in each of branches 14, 15 with which first lever 1 ends. Rotary shaft 11 is oriented parallel to pivot axis 3 of levers 1, 2.

Each of the two disks 44, 45 is provided with three pins 46 obtained by stamping. Pins 46 extend in the direction of the corresponding branch of lever 1, namely pins 46 of disk 44 are oriented towards branch 14 of lever 1, and pins 46 of disk 45 are oriented towards branch 13 of lever 1.

Each of the two branches 13, 14 of lever 1 terminates, beyond the rotary shaft 11 of the two disks 44, 45, in branch end 16, 17. According to the embodiment represented in FIGS. 1 and 2, lever 1 terminates in two L-shaped branches 13, 14 whose transverse part with respect to the general extent of lever 1 constitutes branch end 16, 17. Each of these branch ends 16, 17 is provided with holes 12, 13, with which one of the three pins 46 of each of disks 44, 45 cooperates in order to mark a stop position of wheel 4 for the chosen groove. Thus, in the position represented in FIG. 1, pin 46 of disk 44, engaged in hole 12 of branch end 16 of lever 1, is that which ensures the exact positioning of groove 42 of wheel 4. In the clockwise direction, it is followed by pin 46 ensuring the exact positioning of groove 41 and then pin 46 ensuring the exact positioning of groove 43. In order to change the position of wheel 4, one makes use of the fact that disks 44, 45 are mounted on rotary shaft 11 in such a way that they can be tilted slightly towards one another against the return force of spring 18. Consequently, when the two disks 44, 45 are pressed on the opposite side with respect to the groove currently in position, that is according to FIG. 1, on the edge of wheel 4 where the two corresponding pins 46 are respectively engaged in holes 12 and 13, these pins 46 are made to leave holes 12, 13, which enables the wheel to be turned until one of the other two grooves, 41 or 43, enters into position.

This arrangement of the pins and holes and particularly their cooperation protect the user of the pliers from the consequences of placing his hand dangerously close to the blade 5. Indeed, particularly when the pliers are in the open position, if the user of the pliers grasps the disks of wheel 4 on a part close to blade 5, the coming together of disks 44, 45 in this zone of wheel 4 tends to increase the depressing of pins 46 in holes 12 and 13 instead of causing them to leave the holes. As a consequence, only pressure on the zone of wheel 4 situated on the opposite side from the blade with respect to rotary shaft 11 enables one to release disks 44, 45 in order to be able to turn the wheel to a new position.

It is easily understood that the particular shape of disks 44, 45, suggesting a star-shaped constellation with three branches, can be replaced, without deviating from the principle of the present invention, by two disks with a circular circumference CC as represented in FIG. 2 in the form of broken lines.

In order to immobilize the pliers in the closed position, the pliers are provided with immobilizing means 21 present in this case in the form of pivoting catch 22 mounted on lever 2 and corresponding groove 23 formed in lever 1. Furthermore, for protection of the hands and so that they can be more easily grasped, the pliers according to the invention finally have plastic sleeves 31, 32 provided with flat protuberances 33, 34 mainly intended for protecting the hand in case of small mishaps during the cutting of a tube.

1. A pliers for cutting tubes, comprising:
a first lever and a second lever articulated together on a pivot axis for pivoting between an open position for receiving a tube which is to be cut and a closed position after cutting, wherein
the second lever includes a blade,
the first lever includes a wheel rotatable mounted on first lever and having a periphery including grooves having different widths for receiving tubes of different diameters so that a groove selected according to the diameter of a tube to be cut can be placed opposite the blade when the wheel is turned to a corresponding position.

2. The according to claim 1, wherein the blade has two successive cutting edges between which a point is located.

3. The pliers according to claim 1, wherein the width of each of grooves is smaller than the diameter of the tube which the groove is intended to receive.

4. The pliers according to claim 1, including a shaft mounted on the first lever, wherein the wheel includes two disks that are parallel to one another and mounted coaxially and spaced from one another on the shaft the shaft being parallel to the pivot axis of the first and second levers.

5. The pliers according to claim 4, wherein each disk has pins in the same number as the grooves, the pins cooperating with two holes in the first lever establish a stop position of the wheel for each groove.

6. The pliers according to claim 4, wherein
the first lever has two branches between which the wheel is rotatably mounted,
each of the two branches, terminates beyond the shaft of the two disks, in a branch end including a hole
each disk includes pins in the same number as the grooves, each pin cooperating with a respective hole in a corresponding branch end establish a stop position of the wheel for corresponding groove.

7. The pliers according to claim 4, wherein the disks mounted on the shafts can be tilted towards one another, against a return force.

8. The pliers according to claim 2, including a shaft mounted on the first lever, wherein the wheel includes two disks that are parallel to one another and mounted coaxially and spaced from one another on the shaft, the shaft being parallel to the pivot axis of the first and second levers.

9. The pliers according to claim 8, wherein each disk has pins in the same number as the grooves, the pins cooperating with two holes in the first lever to establish a stop position of the wheel for each groove.

10. The pliers according to claim 8, wherein
the first lever has two branches between which the wheel is rotatably mounted,
each of the two branches terminates beyond the shaft of the two disks, in a branch end including a hole, and
each disk includes pins in the same number as the grooves, each pin cooperating with a respective hole in a corresponding branch end to establish a stop position of the wheel for a corresponding groove.

11. The pliers according to claim 5, wherein the disks mounted on the shaft can be tilted towards one another, against a return force.

12. The pliers according to claim 6, wherein the disks mounted on the shaft can be tilted towards one another, against a return force.

13. The pliers according to claim 8, wherein the disks mounted on the shaft can be tilted towards one another, against a return force.
